(19) United States
(12) Patent Application Publication
(10) Pub. No.: US 2007/0139184 A1
(43) Pub. Date: Jun. 21, 2007

(54) Intelligent remote test/display unit for duct smoke detector

(75) Inventors: Fred M. Butalla III, Joliet, IL (US); David P. Harter, Gilberts, IL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/316,159

(22) Filed: Dec. 21, 2005

(51) Int. Cl. G08B 19/00; G08B 1/08; G08B 17/10

(52) U.S. Cl. 340/521; 340/628; 340/632; 340/539.22

(57) ABSTRACT

A remote accessory unit can communicate via a data protocol with one or more displaced duct detector control units. The accessory unit can present status indicators visually, on a per sensor basis. Both audible and visible annunciators can be provided to indicate an alarm condition.

### FIELD

The invention pertains to ambient condition detectors which can be coupled to various types of heating and/or air conditioning ducts. More particularly, the invention pertains to duct detectors which incorporate one or more programmable processors to provide predetermined functions as well as displaced test/display units.

### BACKGROUND

One duct detector structure has been disclosed in U.S. Pat. No. 6,124,795 entitled “Detector Interconnect System”, issued Sep. 26, 2000. The '795 patent is assigned to the Assignee hereof and is incorporated herein by reference.

Many of the known duct smoke detectors incorporate a smoke sensor and a power supply board which incorporates power supply circuitry and alarm indicating relays. In such smoke detectors, the smoke sensor unit makes an alarm determination. The circuitry on the power board then receives a signal from the smoke sensor indicating an alarm condition and responds thereto by activating local alarm indicating relays, and/or light emitting diodes to indicate an alarm condition. Such power boards are unable to make decisions based on multiple detected conditions where the unit incorporates more than one smoke sensor. Further, such power boards are unable to signal the condition of the respective sensors to a displaced display/input unit in the absence of extra conductors.

Remote test accessories or devices have been used with duct smoke detectors. Such devices can be mounted on a wall or ceiling and connect to a respective one or more duct smoke detector(s). Such detector(s) might be mounted in an inconvenient location such as in the ceiling of the respective building, or floor of a multi-floor structure. Such devices provide convenient access to an indicator of status of the respective sensor. They can also be used to test and/or reset the respective detector structure.

Known test accessories are usually connected to the respective detector's relay(s) to obtain status signals. Known accessories have been limited to providing status information for only a single sensor. Such accessories often require numerous wires to transfer signals back and forth to/from the respective duct detector.

There continues to be a need for test/display devices or accessories that provide a greater degree of functionality to users than is currently available. It would be desirable to reduce the number of wires needed for communications between the respective duct detector assembly and the respective test/display unit. It would also be desirable to be able to separately test each of several different sensors of the duct detector assembly. It would also be desirable to provide such additional functionality without substantially increasing the manufacturing cost or complexity of such accessories.

### BRIEF DESCRIPTION OF THE DRAWINGS

FIG. 1 is an overall block diagram in accordance with the invention; and

FIG. 2 is a block diagram illustrating various aspects of a remote test/display unit in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

A duct detector can incorporate one or more ambient condition sensors or detectors, a programmable control processor along with a control program or a state machine. A plurality of relays and visual alarm indicating devices can also be provided.

The programmable processor, in combination with the control software or a state machine, can receive signals from one or more ambient condition sensors coupled thereto. The processor and control software can process and filter the signals and make an alarm determination relative to each of the ambient condition sensors of the unit. Types of sensors include smoke sensors, gas sensors and the like all without limitation.

The programmable processor and associated control program or a state machine can evaluate the condition of one or more ambient condition sensors and determine, for example, sensitivity of the respective device as well as any other parameters of interest. In that regard, the programmable processor or state machine can adjust alarm thresholds, filter signals received from the respective sensors as well as carryout alarm condition processing using inputs from one or more of the associated sensors. Further, in conjunction with a remote test/display unit, the programmable processor or state machine and associated control circuitry can provide information as to condition and alarm state on a per sensor basis. Additionally, the programmable processor or state machine and associated control circuitry can provide control signals to one or more local alarm indicating visual output devices such as light emitting diodes.

The programmable processor and associated control program or a state machine can assign different priorities to the various sensors. Priorities could be used to make decisions as to driving common alarm indicating relays without affecting the state of visible status indicators associated with each sensor. Trouble conditions can also be determined on a per sensor basis.

The present programmable processor and associated control program or a state machine can communicate with displaced sensors. In this embodiment, one sensor could be located for example in the supply air side of an air handling unit. The other could be located in the return air side of an air handling unit. In other configurations, the multiple sensors could be incorporated into a common housing with the programmable processor and associated control software or the state machine.

In accordance with the invention, a remote test/display unit or accessory can incorporate a digital or analog communication protocol to communicate with a control/power unit of a duct smoke detector. In this regard, the accessory can test and evaluate the operational condition of multiple sensors by communicating to the duct smoke detector control unit commands or information as to which of the sensors is to be tested. Multiple sensors can be in different states. In accordance with the invention, the status of each respective sensor can be provided. For example, the status of each such sensor can be separately displayed. Further, information on a per sensor basis, such as a sensitivity measurement, can also be provided.

The test accessory can incorporate a programmable processor as well as associated control circuitry. A variety of digital or analog communications protocols can be used to communicate between the remote test accessory and the respective control/power unit of the smoke detector(s).

Further in accordance with another aspect of the invention, the remote test accessory can provide visual and/or audible status indicators for each of the respective sensors. Alarm or trouble conditions, on a per sensor basis, can also be indicated both visually and audibly. In yet another aspect of the invention, user inputs can be provided for test and reset purposes. Test and reset commands could be sent via a communication link to the control/power unit for the duct smoke detector. The respective command can require that the one or more specified sensors be tested and evaluated. A response can be provided by the control/power unit to the remote accessory unit.

In yet another aspect of the invention, sensitivity measurements or other parameter information can be coupled to the remote accessory unit. Hence, it will no longer be necessary to be local to the respective control/power unit or associated sensors. Feedback can be provided to the remote test/display unit on a per sensor basis as to whether or not the respective sensor is in a standby condition, indicating a need for maintenance or whether the sensor is indicating a trouble condition.

Further, the use of a digital or analog communication protocol, whether wired or wireless, alleviates any need for multiple wires for various indicators, conditions or relays. Where a wired communication link is used, the remote accessory can communicate, relative to multiple sensors, with only power wires and a bi-directional communication signal wire. Communication can also be accomplished using power wires, one input communication signal wire, and one output communication signal wire.

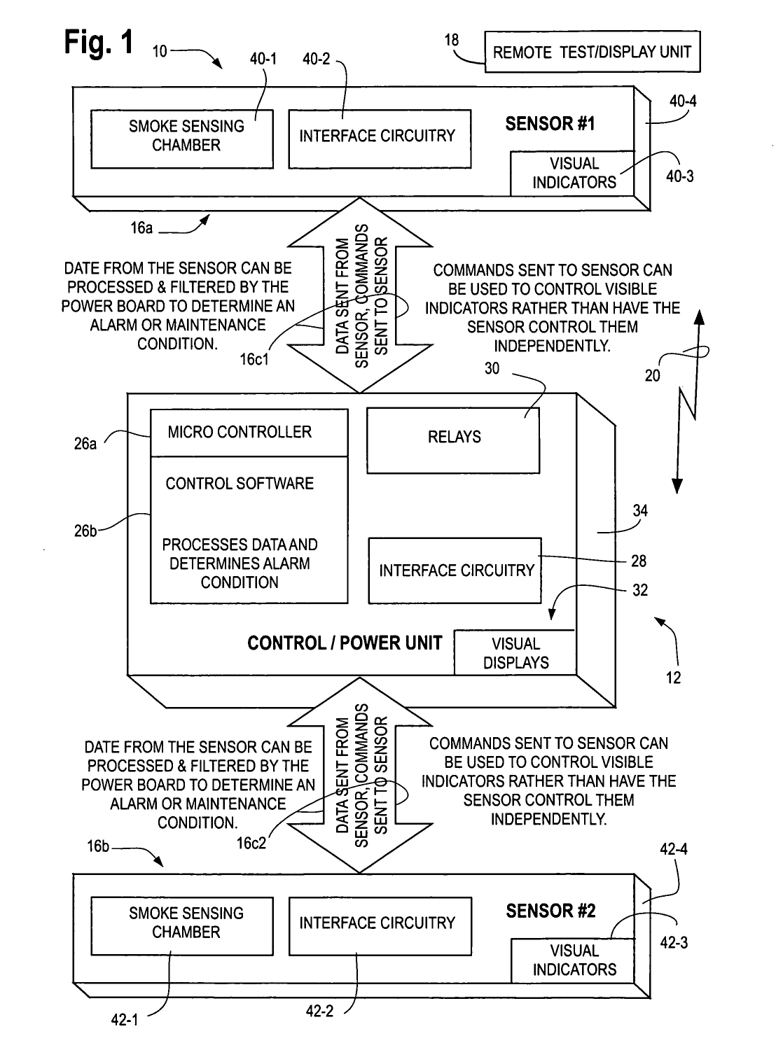

FIG. 1 illustrates system 10. The system 10 includes a control/power unit 12 which is in wired or wireless communication with a plurality of sensors such as sensor 16a and sensor 16b. It will be understood that the type of sensor is not a limitation of the invention. Sensors 16a,b could include smoke sensors of various types, as well as gas sensors all without limitation. Further, one or more of the sensors such as 16a,b could be coupled to the control and power unit 12.

The system 10 can also incorporate a remote test/display unit 18. The unit 18 can be in wired or wireless communication with the control/power unit 12 via medium 20.

Each of the sensors 16a, 16b can also be in wired or wireless communication with the control/power unit 12 via medium 16c1-c2. Communications can be implemented via a binary or analog transmission protocol.

Control/power unit 12 can include control circuitry implemented as a programmable processor 26a and associated control software 26b or a state machine. The control hardware and software 26a,b or state machine can be coupled via interface circuitry 28 to local condition indicating relays 30, as well as to the various sensors 16a,b and remote accessory unit 18. If desired, local visual displays 32 could also be coupled to interface circuitry 28. The unit 12 can be incorporated into a closed housing 34 if desired.

Unit 12, as noted above, via medium 16c1,c2 is in bidirectional communication with respective sensors indicated at 16a, 16b. The sensors can be the same or different without departing from the scope and spirit of the present invention. In FIG. 1, sensor 16a, incorporates a sensing chamber which could be a smoke sensing chamber 40-1 which is in turn coupled to interface and control circuitry as appropriate 40-2. The circuitry 40-2 is in bi-directional communication via medium 16c1 with the unit 12. Sensor 16a can incorporate visual output devices 40-3 and be carried in a housing 40-4.

The sensor 16b can also incorporate an ambient sensing chamber, such as a smoke sensing chamber 42-1 which is in turn coupled to control and interface circuitry 42-2. The sensor 16b is in bi-directional communication via control interface circuitry 42-2 and medium 16c2 with unit 12. Sensor 16b can also incorporate visual output devices such as the light emitting diodes 42-3. The sensor 16b can also be carried by or within a housing 42-4.

The programmable control unit 26a and associated control software 26b or a state machine of unit 12 can communicate with the sensors such as sensors 16a,b by sending one or more commands over the respective medium 16c1, 16c2. Commands can be used for example to control visual output devices such as 40-3, 42-3 as well as to query the respective sensors such as 16a,b for data.

Data could also be provided by the respective sensor on a predetermined basis to the unit 12. The unit 12 can filter incoming sensor signals in hardware or software. Various processes could be executed in determining the existence of an alarm, maintenance or trouble condition. The unit 12 can initiate an alarm condition based on an analysis of data received from the respective sensor, and can activate the relays 30 in accordance therewith as well as visual output devices such 32, 40-3 as well as 42-2. Further, the unit 12 can notify the remote accessory 18 via medium 20 as to the existence of a determined alarm state. The unit 12 can also indicate a trouble condition or the need for maintenance as would be understood by those of skill in the art.

The remote test/display unit 18 can send one or more test commands to the control/power unit 12. The unit 12 will in turn evaluate the condition of the respective sensors and communicate with the remote accessory 18 accordingly. Sensor status includes, standby, alarm, maintenance or trouble. The unit 12 can also take other actions as a response to the test commands from the remote test/display unit 18.

The unit 12 in communicating with accessory 18 via medium 20 can utilize a predetermined communications protocol for the transfer of information therebetween. Where the medium 20 is a wired medium, the use of a communication scheme results in needing fewer wires between the unit 12 and the remote accessory 18 to communicate the desired information. The communications protocol between units 12 and 18 is not a limitation of the present invention.

A variety of protocols as would be understood by those of skill in the art for transmitting digital or analog data between the units 12 and 18 could be used without departing from the spirit and scope of the present invention. In summary, the unit 12 can communicate the status of multiple sensors, whether they are in a standby condition, alarm condition, maintenance or trouble condition independently of the state or states any other sensor such as 16a or 16b is exhibiting.

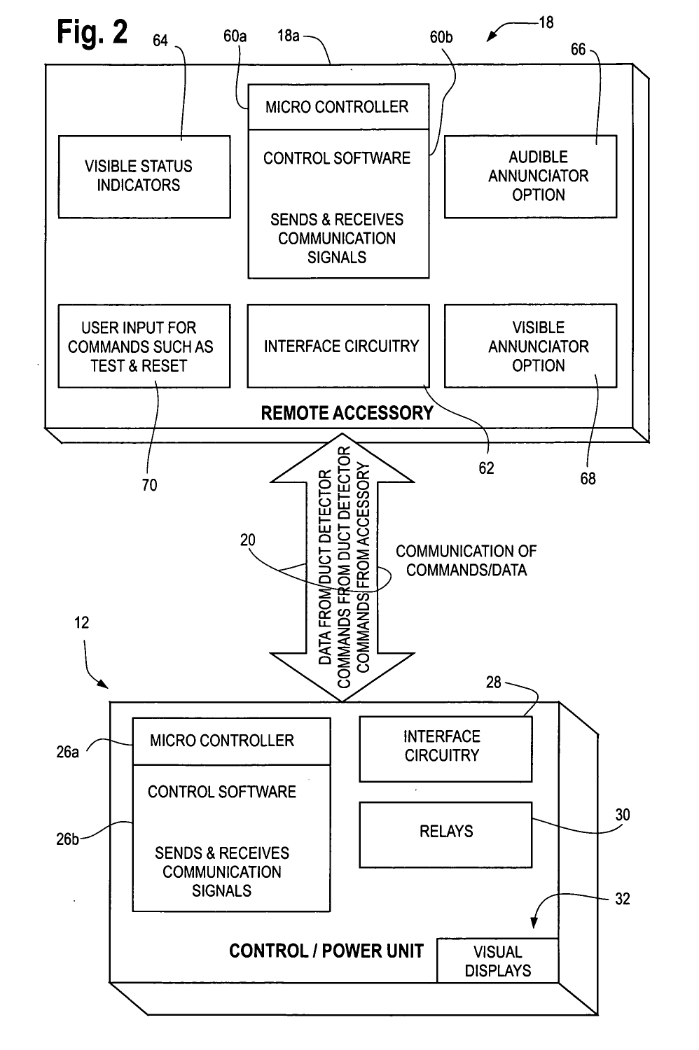

FIG. 2 illustrates additional details of the remote test/display unit 18 in accordance with the invention. The unit 18 can be incorporated into a closed housing 18a.

Control circuitry can include a programmable processor or controller 60a and associated control software 60b or a state machine. The processor 60a can be coupled to interface circuitry 62 for carrying out digital or analog communications via medium 20, wired or wirelessly, with one or more control/power units 12.

The accessory unit 18 can also incorporate a plurality of visual status indicators 64, one or more audible indicators or enunciators 66, as well as one or more visual enunciators out 68. One or more user inputs 70 can be provided for directing a test or reset commands, or any other commands, to the control/power unit 12.

Remote accessory unit 18 can communicate commands to the control unit 12, via medium 20. It can also receive information or data from unit 12 pertaining to one or more sensors and can also receive commands therefrom all without limitation. The status indicators 64 can indicate, on a per sensor basis, a standby state, an alarm state, a maintenance needed state and/or a trouble state.

In summary, unit 18 can transmit commands to and receive data from control element 12 using a predetermined binary transmission protocol. As a result, only a limited number of conductors is needed, where a wired medium couples the unit 18 and the element 12 together, irrespective of the number of commands and nature or extent of the data.

It will be understood that element 12, unit 18 as well as any associated sensors can be implemented using a variety of technologies without departing from the spirit and scope of the invention. Programmable processors and associated software can be used, field programmable gate arrays can be used as well as hardwired logic as appropriate.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A system comprising:
a control and display device, the device including a display for visually presenting status of at least two different duct sensors, a communications interface, and control circuits coupled to the display and the interface, the control circuits transmit and receive binary or analog commands for the duct sensors via the interface to a displaced recipient.

2. A system as in claim 1 where the device includes at least one manually operable duct sensor command input element.

3. A system as in claim 1 where the device includes a plurality of manually operable duct sensor command input elements.

4. A system as in claim 2 where the interface circuitry includes circuitry that transmits and receives data via at least one of a wired or wireless medium.

5. A system as in claim 4 where binary or analog data is transmitted to the recipient by the circuitry that transmits and receives.

6. A system as in claim 5 where at least some of the binary or analog data comprises duct sensor commands.

7. A system as in claim 6 where the at least one input element specifies a sensor to which a command is directed.

8. A system as in claim 7 where binary or analog data is received from the recipient by the circuitry that transmits and receives.

9. A system as in claim 8 where the control circuits include control software which couples duct sensor commands to the communications interface.

10. A system as in claim 8 where the control circuits include a state machine which couples duct sensor commands to the communications interface.

11. A system as in claim 8 where the control circuits include control software which receives duct sensor feedback from the communications interface.

12. A system as in claim 8 where the control circuits include a state machine which receives duct sensor feedback from the communications interface.

13. A system comprising:
a display device, the device including a display for visually presenting status of at least two different duct sensors and a communications interface, the communications interface receives binary or analog data from the duct sensors via the interface.

14. A system as in claim 13 where the interface circuitry includes circuitry that receives data via at least one of a wired or wireless medium.

15. A system as in claim 14 where the circuits include software which receives duct sensor data from the communications interface.

16. A system as in claim 14 where the circuit includes a state machine which receives duct sensor data from the communications interface.

17. A system as in claim 13 that includes circuitry for measuring and transmitting the sensitivity information of multiple sensors.

18. A system as in claim 13 where the device includes an audible enunciator.

19. A system as in claim 13 where the device includes a visible enunciator.
